(19) United States
(12) Patent Application Publication
(10) Pub. No.: US 2013/0248337 A1
(43) Pub. Date: Sep. 26, 2013

(54) KEYCAP AND METHOD OF MANUFACTURING THE SAME

(71) Applicant: DARFON ELECTRONICS CORP., Taoyuan (TW)

(72) Inventors: Tsai-Jung Hu, Taoyuan (TW); Ya-Ting Chang, Taoyuan (TW)

(73) Assignee: DARFON ELECTRONICS CORP., Taoyuan (TW)

(21) Appl. No.: 13/776,713

(22) Filed: Feb. 26, 2013

(30) Foreign Application Priority Data
Mar. 21, 2012 (TW) 101109635

(51) Int. Cl. H01H 9/02; B29C 59/16

(52) U.S. Cl. CPC H01H 9/02; B29C 59/16
USPC 200/304; 264/400

(57) ABSTRACT

A keycap and a method of manufacturing the same are disclosed. The method is to injection-mold a cap with a layer structure of ink thereon by an in-mold transfer method; then, to form a pattern on the layer structure of ink by a high energy optical engraving method; and at last, to form a light-permeable protection layer on the layer structure of ink to cover the pattern. The keycap according to the invention is therefore obtained. Therefore, the invention can reduce the manufacturing time relatively to a conventional keycap with a pattern formed thereon, such as a keycap for backlight keyboard. Furthermore, the invention can improve the binding strength between the layer structure of ink and the cap by use of the in-mold transfer method.

### BACKGROUND OF THE INVENTION

1. Field of the Invention

The invention relates to a keycap and a method of manufacturing keycap, and especially relates to a keycap with pattern thereon and a method therefor.

2. Description of the Prior Art

Current keycaps are usually made by injection-molding. If it is required to form a pattern on the keycap, the pattern is usually formed in another process separate from the above injection-molding process. For an example of a keycap used in a backlight keyboard, a transparent cap is first formed by injection-molding. The cap is then printed or coated with multiple layers of ink thereon by an order. A pattern is formed by using laser light to cut (or mark) the multiple layers of ink. At last, a protection gel layer is formed on the multiple layers, especially over the pattern by spraying and is treated by a curing process. Afterward, the keycap with the pattern is therefore obtained. Therefore, the keycap needs many processes, leading to a great consumption of time, especially of much time to form the multiple layers of ink. Besides, the variations of the processes are large relatively.

### SUMMARY OF THE INVENTION

An objective of the invention is to provide a method of manufacturing keycap, which uses an in-mold transfer method and a high energy optical engraving method to manufacture a keycap with a pattern thereon so as to reduce the total manufacturing time and further to improve the manufacturing stability.

The method of manufacturing keycap of the invention includes the following steps: injection-molding a cap with a layer structure of ink thereon by an in-mold transfer method; then forming a pattern on the layer structure of ink by a high energy optical engraving method; and afterward forming a light-permeable protection layer on the layer structure of ink to cover the pattern. Therefore, the invention uses the in-mold transfer method for enhancing the efficiency of forming the layer structure of ink on the cap and also for improving the binding strength between the layer structure of ink and the cap, which solves the problems in the prior art that the conventional manufacturing of a keycap with a pattern formed thereon consumes much time and the variations of the processes are large relatively.

Another objective of the invention is to provide a keycap, which is made by the method of the invention. The keycap of the invention includes a cap, a layer structure of ink, and a light-permeable protection layer. The layer structure of ink is formed on the cap by an in-mold transfer method and has a pattern which is formed by a high energy optical engraving method. The light-permeable protection layer is formed on the layer structure of ink to cover the pattern. Similarly, the invention uses the in-mold transfer method to improve the binding strength between the layer structure of ink and the cap, which enhances the product reliability.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top view of a keycap of a preferred embodiment according to the invention.

FIG. 2 is a sectional view of the keycap along the line X-X in FIG. 1.

FIG. 3 is a primary flow chart of a method of manufacturing keycap according to the invention.

FIG. 4 is a detailed flow chart for manufacturing the keycap in FIG. 1.

FIG. 5 is a sectional view of a transfer film used in the manufacturing flow by FIG. 4.

FIGS. 6 through 11 are schematic diagrams illustrating the manufacturing according to the flow chart shown by FIG. 4.

FIG. 12 is a sectional view of a keycap of another preferred embodiment according to the invention.

FIG. 13 is a sectional view of a transfer film used for the keycap in FIG. 12.

### DETAILED DESCRIPTION

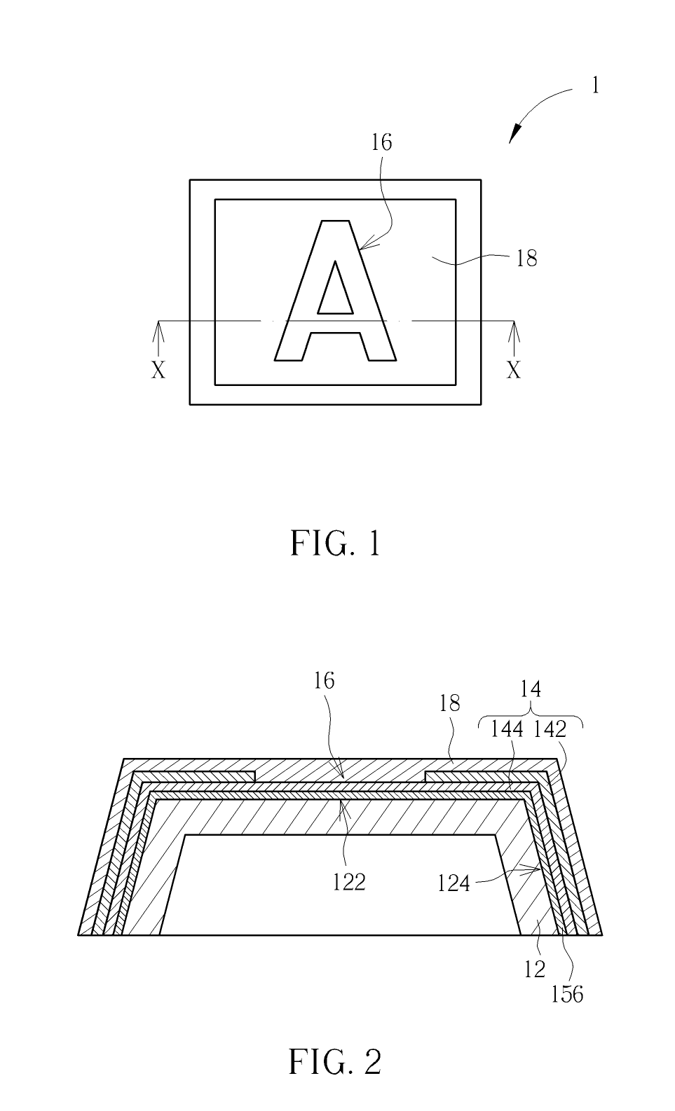

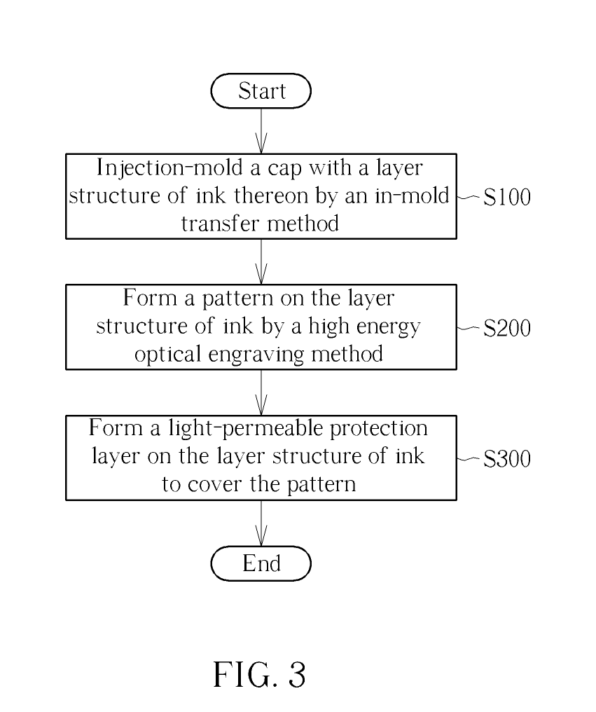

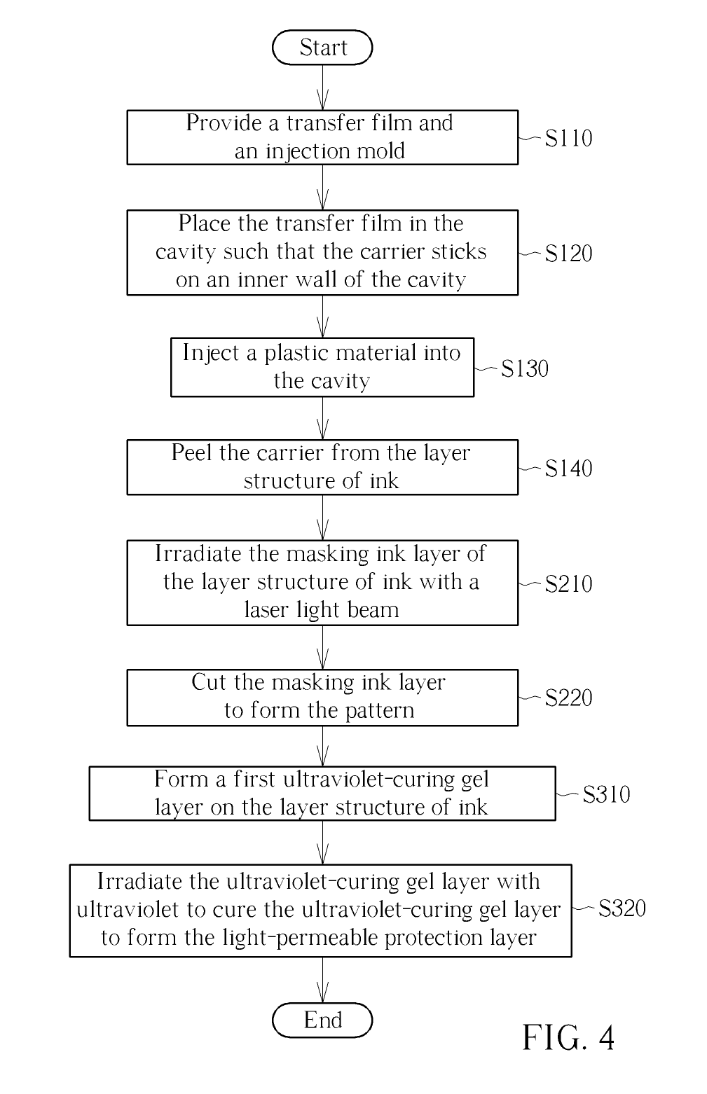

Please refer to FIGS. 1 through 3. FIG. 1 is a top view of a keycap 1 of a preferred embodiment according to the invention. FIG. 2 is a sectional view of the keycap 1 along the line X-X in FIG. 1. FIG. 3 is a primary flow chart of a method of manufacturing keycap according to the invention. As shown by the step S100, the method is first to injection-mold a cap 12 with a layer structure of ink 14 thereon by an in-mold transfer method. As shown by the step S200, the method is then to form a pattern 16 on the layer structure of ink 14 by a high energy optical engraving method. In the embodiment, the pattern 16 presents a letter A, but the invention is not limited thereto. Afterward, as shown by the step S300, the method is to form a light-permeable protection layer 18 on the layer structure of ink 14 to cover the pattern 16. Thereby, the manufacturing of the keycap 1 uses the in-mold transfer method for enhancing the efficiency of forming the layer structure of ink 14 on the cap 12 and also for improving the binding strength between the layer structure of ink 14 and the cap 12, which solves the problems in the prior art that the conventional manufacturing of a keycap with a pattern formed thereon consumes much time and the variations of the processes are large relatively.

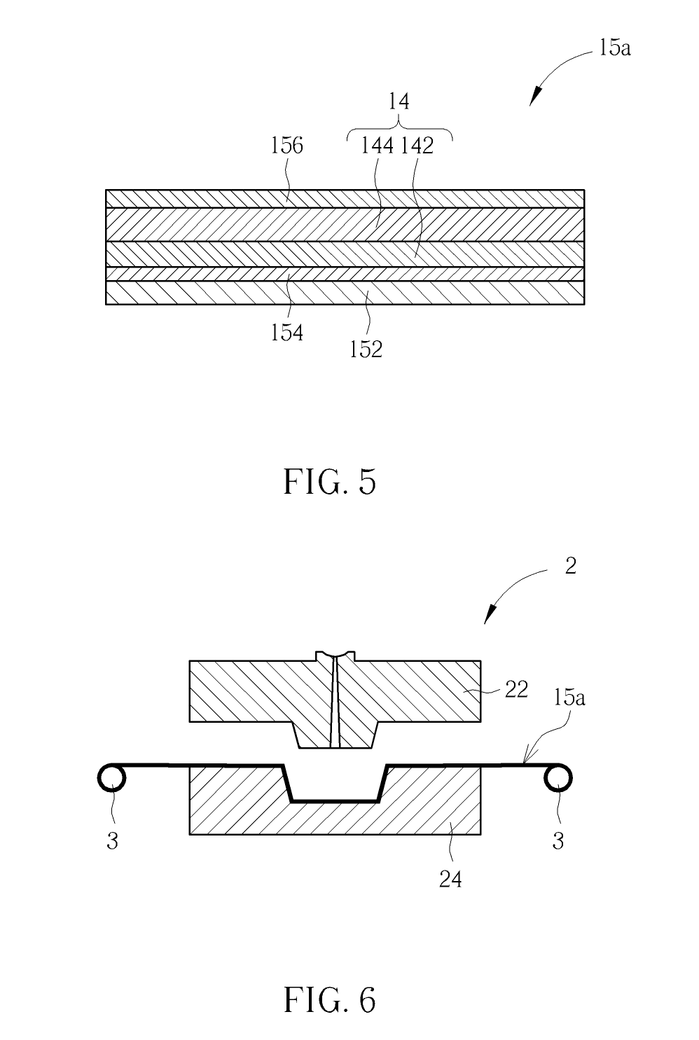

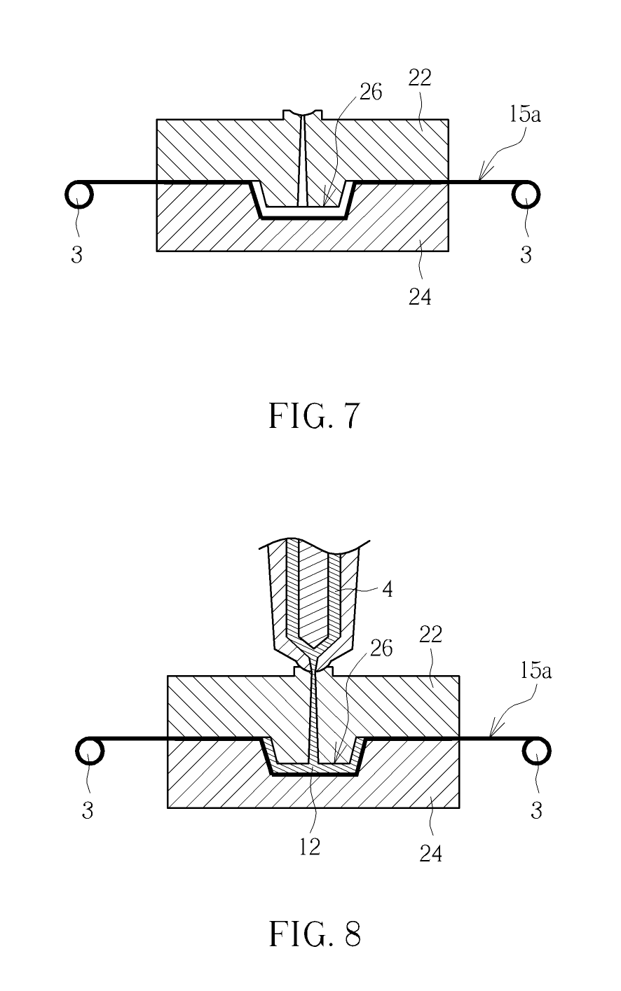

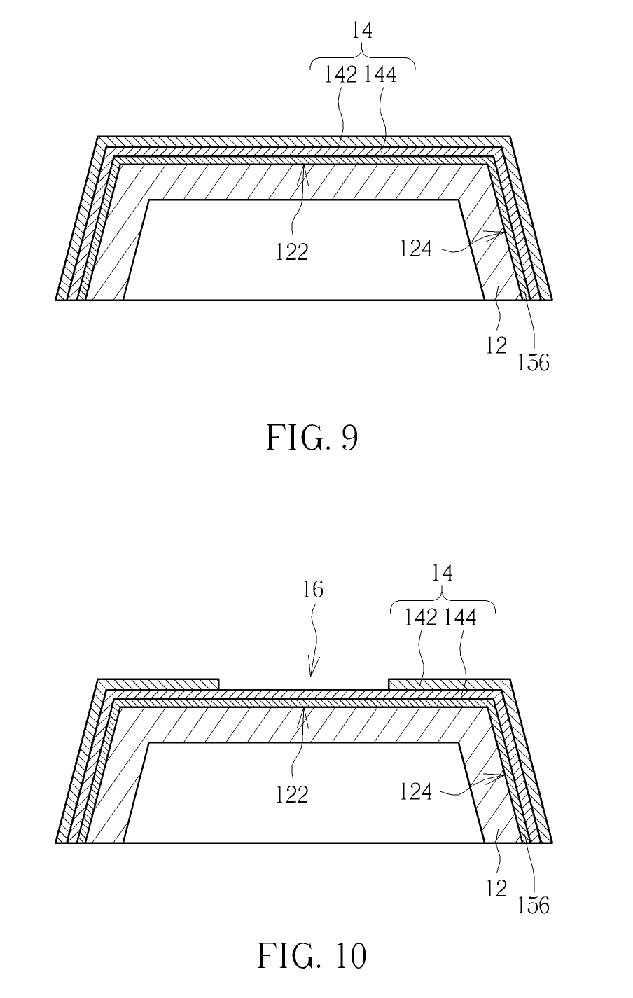

In the embodiment, the in-mold transfer method uses a method of in-mold decoration by roller in the art of in-mold decoration. The high energy optical engraving method uses laser light. These will be described further later, but the invention is not limited thereto. Please also refer to FIGS. 4 through 11. FIG. 4 is a detailed flow chart for manufacturing the keycap 1. FIG. 5 is a sectional view of a transfer film 15a used in the manufacturing flow by FIG. 4. FIGS. 6 through 11 are schematic diagrams illustrating the manufacturing according to the flow chart shown by FIG. 4; therein, the transfer film 15a is shown by bold lines in FIGS. 6 through 8.

In the embodiment, the step S100 in FIG. 3 is implemented by the steps S110, S120, S130 and S140 in FIG. 4. As shown by the step S110, the method of manufacturing keycap includes providing a transfer film 15a and an injection mold 2. As shown in FIG. 5, the transfer film 15a is a layer structure and includes a carrier 152, a release layer 154 formed on the carrier 152, a masking ink layer 142 formed on the release layer 154, a light-permeable ink layer 144 formed on the masking ink layer 142, and an adhesive layer 156 formed on the light-permeable ink layer 144. Therein, the masking ink layer 142 and the light-permeable ink layer 144 form the layer structure of ink 14. As shown in FIG. 6 and FIG. 7, the injection mold 2 includes an upper mold 22 and a lower mold 24. The upper mold 22 and the lower mold 24 join with each other to form a cavity 26 therebetween.

As shown by the step S120, the method is then to place the transfer film 15a in the cavity 26 such that the carrier 152 sticks on an inner wall of the cavity 26. In a practical operation, the transfer film 15a is placed on the lower mold 24 corresponding to the cavity 26 by rollers 3 and sticks on the inner wall closely further by vacuum absorption, as shown in FIG. 6. Afterward, the method is to join the upper mold 22 with the lower mold 24 to form the cavity 26, as shown in FIG. 7.

As shown by the step S130, the method is then to inject a plastic material 4 into the cavity 26, as shown in FIG. 8. When the plastic material 4 in the cavity 26 becomes cool to form the cap 12, the layer structure of ink 14 sticks on the cap 12 by the adhesive layer 156. Because the plastic material 4 is compressed to be injected into the cavity 26, the binding strength between the cap 12 and the layer structure of ink 14 is usually stronger than that by a method of spraying or spreading adhesive under normal temperature and pressure, which avoids peeling of the layer structure of ink 14. In addition, in the embodiment, the keycap 1 is used for a backlight keyboard. The plastic material 4 is made of light-permeable plastic material so that the cap 12 is light-permeable. However, the invention is not limited thereto.

After the injection mold 2 is opened, the cap 12 with a part of the transfer film 15a thereon can be taken out from the cavity 26. As shown by the step S140, By use of the release layer 154, the carrier 152 can be peeled off from the layer structure of ink 14. After the peeling, a sectional view of the cap 12 with the layer structure of ink 14 attached thereon is shown by FIG. 9.

In the embodiment, the step S200 in FIG. 3 is implemented by the steps 5210 and 5220 in FIG. 4. As shown by the step S210, the method of manufacturing keycap is then to irradiate the masking ink layer 142 of the layer structure of ink 14 with a laser light beam. As shown by the step S220, the method is to cut (or mark) the masking ink layer 142 to form the pattern 16; the light-permeable ink layer 144 is still reserved. The cap 12 with the layer structure of ink 14 after the cutting (or marking) is shown in FIG. 10; therein, the pattern 16 is located on the top surface 122 of the cap 12.

In the embodiment, the step S300 in FIG. 3 is implemented by the steps 5310 and 5320 in FIG. 4. As shown by the step S310, the method of manufacturing keycap is then to form a first ultraviolet-curing gel layer 19a on the layer structure of ink 14, as shown in FIG. 11; therein, the first ultraviolet-curing gel layer 19a is formed on the top surface 122 and the side surfaces 124 of the cap 12 to cover the pattern 16. In practice, the hollow portion of the pattern 16 can be filled with the first ultraviolet-curing gel layer 19a. As shown by the step S320, the method is then to irradiate the ultraviolet-curing gel layer 19a with ultraviolet to cure the ultraviolet-curing gel layer 19a to form the light-permeable protection layer 18, as shown in FIG. 2. Afterward, the keycap 1 is therefore obtained.

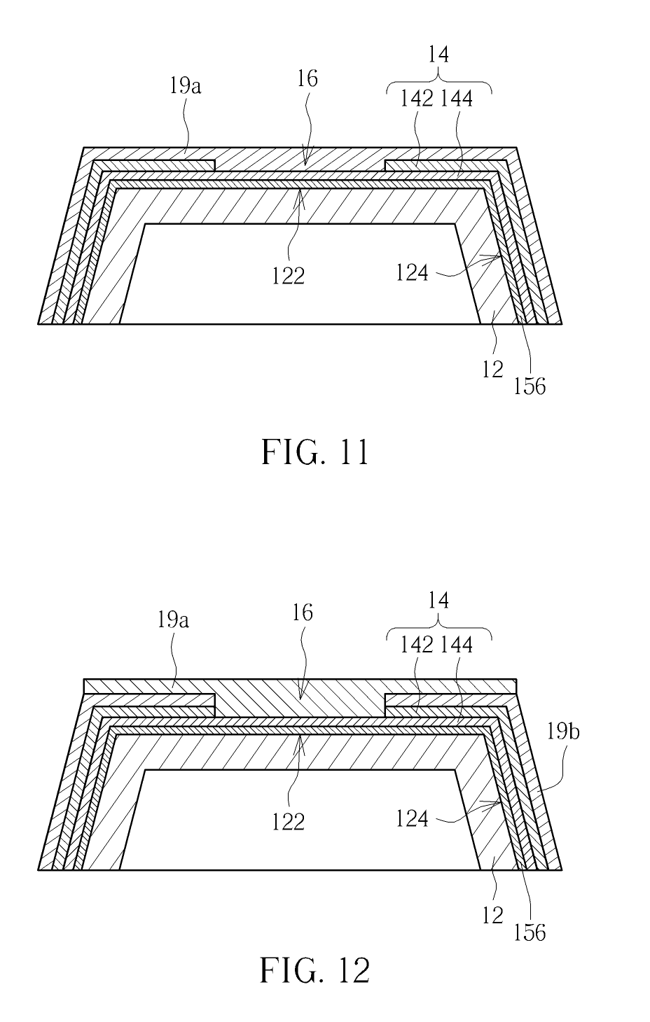

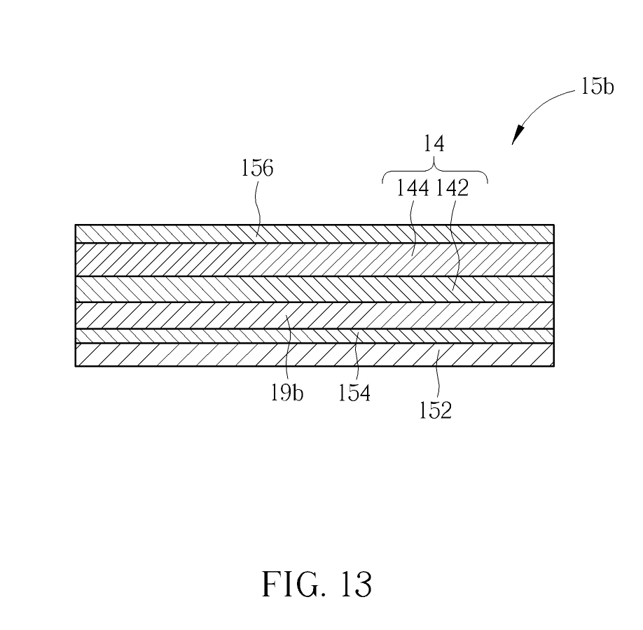

Please refer to FIG. 12 and FIG. 13. FIG. 12 is a sectional view of a keycap 5 of another preferred embodiment according to the invention. FIG. 13 is a sectional view of a transfer film 15b used for the keycap 5 in FIG. 12. In the embodiment, compared to the transfer film 15a, the transfer film 15b further includes a second ultraviolet-curing gel layer 19b located between the release layer 154 and the masking ink layer 142; that is, the release layer 154, the second ultraviolet-curing gel layer 19b, the layer structure of ink 14 and the adhesive layer 156 are formed on the carrier 152 in order. Therefore, in the above step S140, the carrier 152 is peeled off from the second ultraviolet-curing gel layer 19b by the release layer 154. In the above steps S210 and S220, the laser light beam cuts (or marks) the second ultraviolet-curing gel layer 19b and the layer structure of ink 14 simultaneously to form the pattern 16; that is, the pattern 16 is formed by the second ultraviolet-curing gel layer 19b and the layer structure of ink 14 simultaneously and is located above the top surface 122 of the cap 12. The second ultraviolet-curing gel layer 19b has covered the top surface 122 and the side surfaces 124 of the cap 12, so in the above step S310, the first ultraviolet-curing gel layer 19a just needs to be formed on the second ultraviolet-curing gel layer 19b and above the top surface 122 of the cap 12 to cover the pattern 16. Therefore, the layer structure of ink 14 is covered by the first ultraviolet-curing gel layer 19a together with the second ultraviolet-curing gel layer 19b. Besides, in the above step S320, the ultraviolet irradiates the first ultraviolet-curing gel layer 19a and the second ultraviolet-curing gel layer 19b simultaneously to be cured to form the light-permeable protection layer 18; that is, the light-permeable protection layer is formed by the ultraviolet-cured layers by curing the ultraviolet-curing gel layers 19a and 19b. Similarly, such light-permeable protection layer 18 also can provide entire protection to the layer structure of ink 14 and the pattern 16.

It is added that in practice, the transfer films 15a and 15b are not limited to the layer structures disclosed in the above embodiments. It goes without saying that they can include more layers in accordance with an actual product specification. In addition, in the above embodiments, the keycaps 1 and 5 use the ultraviolet-cured layers formed by curing the ultraviolet-curing gel layers 19a and 19b, but the invention is not limited thereto. In practice, any structure capable of forming a light-permeable protection layer can be taken as the light-permeable protection layer 18 of the invention, such as hardened resin.

As discussed above, compared with the prior art, the invention uses the in-mold transfer method to greatly save the manufacturing time of attaching the layer structure of ink on to the cap and also to enhance the binding strength between the layer structure of ink and the cap so as to effectively reduce the peeling probability of the layer structure of ink. Furthermore, the invention uses the transfer film to form the layer structure of ink with uniform thickness, which can solve a problem of non-uniform coated thickness due to a spraying angle of a conventional spraying method. In addition, when the used transfer film includes a curing gel layer (such as the ultraviolet-curing gel layer), after the pattern is formed, only the portion of the cap corresponding to the pattern (i.e. the top surface of the cap) needs to be covered by another hardened layer. Thereby, the purpose of the complete protection effect on the layer structure of ink also can be achieved. Besides, the extent of non-uniform thickness which is maybe produced by the coating of the curing gel layer on the cap can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of manufacturing keycap, comprising the following steps:
(a) injection-molding a cap with a layer structure of ink thereon by an in-mold transfer method;
(b) forming a pattern on the layer structure of ink by a high energy optical engraving method; and
(c) forming a light-permeable protection layer on the layer structure of ink to cover the pattern.

2. The method of claim 1, wherein the step (a) is implemented by the following steps:
providing a transfer film which is a layer structure and comprises a carrier and the layer structure of ink formed on the carrier;
providing an injection mold having a cavity;
placing the transfer film in the cavity such that the carrier sticks on an inner wall of the cavity;
injecting a plastic material into the cavity so as to form the cap with the layer structure of ink thereon; and
peeling the carrier from the layer structure of ink.

3. The method of claim 2, wherein in the step (a), the transfer film comprises a release layer and an adhesive layer, the release layer is formed between the carrier and the layer structure of ink, the adhesive layer is formed on the layer structure of ink, the layer structure of ink is attached on the cap by the adhesive layer, and the carrier is peeled from the layer structure of ink by the release layer.

4. The method of claim 1, wherein in the step (b), the high energy optical engraving method uses laser light.

5. The method of claim 1, wherein in the step (b), the layer structure of ink comprises a light-permeable ink layer and a masking ink layer, the light-permeable ink layer is located between the cap and the masking ink layer, and the high energy optical engraving method uses a laser light beam to cut the masking ink layer to form the pattern.

6. The method of claim 1, wherein the step (c) is implemented by the following steps:
forming a first ultraviolet-curing gel layer on the layer structure of ink; and
irradiating the first ultraviolet-curing gel layer with ultraviolet to be cured to form the light-permeable protection layer.

7. The method of claim 6, wherein in the step (c), the cap has a top surface and a side surface, the pattern is located above the top surface, and the first ultraviolet-curing gel layer is formed above the top surface and the side surface.

8. The method of claim 6, wherein:
in the step (a), the in-mold transfer method uses a transfer film which is a layer structure and comprises a carrier, a release layer, a second ultraviolet-curing gel layer, a adhesive layer, and the layer structure of ink, the release layer, the second ultraviolet-curing gel layer, the layer structure of ink, and the adhesive layer are formed in order on the carrier, the cap has atop surface and a side surface, the second ultraviolet-curing gel layer and the layer structure of ink are attached on the top surface and the side surface by the adhesive layer, the carrier is peeled from the second ultraviolet-curing gel layer by the release layer;
in the step (b), the high energy optical engraving method uses a laser light beam to cut the second ultraviolet-curing gel layer and the layer structure of ink simultaneously to form the pattern, the pattern is located above the top surface; and
in the step (c), the first ultraviolet-curing gel layer is formed on the second ultraviolet-curing gel layer and is located above the top surface, the first ultraviolet-curing gel layer and the second ultraviolet-curing gel layer are irradiated simultaneously with ultraviolet to be cured to form the light-permeable protection layer.

9. The method of claim 1, wherein in the step (a), the cap is formed by injection-molding a light-permeable plastic material.

10. A keycap, comprising:
a cap;
a layer structure of ink formed on the cap by an in-mold transfer method, the layer structure of ink having a pattern which is formed by a high energy optical engraving method; and
a light-permeable protection layer formed on the layer structure of ink and covering the pattern.

11. The keycap of claim 10, further comprising an adhesive layer sticking the layer structure of ink on the cap.

12. The keycap of claim 10, wherein the layer structure of ink comprises a light-permeable ink layer and a masking ink layer, the light-permeable ink layer is located between the cap and the masking ink layer, and the pattern is formed by the masking ink layer.

13. The keycap of claim 10, wherein the light-permeable protection layer is a first ultraviolet-cured layer.

14. The keycap of claim 13, wherein the cap has a top surface and a side surface, the pattern is located above the top surface, and the light-permeable protection layer is formed above the top surface and the side surface.

15. The keycap of claim 10, wherein the cap has a top surface and a side surface, the light-permeable protection layer comprises a first ultraviolet-cured layer and a second ultraviolet-cured layer, the second ultraviolet-cured layer is formed on the layer structure of ink, the first ultraviolet-cured layer is formed on the second ultraviolet-cured layer and is located above the top surface, and the pattern is formed simultaneously by the second ultraviolet-cured layer and the layer structure of ink and is located above the top surface.

16. The keycap of claim 10, wherein the cap is light-permeable.
